(19) United States
(12) Patent Application Publication
(10) Pub. No.: US 2019/0068983 A1
(43) Pub. Date: Feb. 28, 2019

(54) Sending a Frame Difference or Raw Chunk Based on a Known Acknowledgement

(71) Applicant: Advanced Micro Devices, Inc., Sunnyvale, CA (US)

(72) Inventors: Stephen Mark Ryan, Lilydale (AU); Darren Rae Di Cera, Reservoir (AU)

(21) Appl. No.: 15/686,892

(22) Filed: Aug. 25, 2017

(51) Int. Cl. H04N 19/196; H04N 19/105; H04N 19/159; H04N 19/172; H04N 19/597; H04N 19/164

(52) U.S. Cl. CPC H04N 19/197; H04N 19/105; H04N 19/164; H04N 19/172; H04N 19/597; H04N 19/159

(57) ABSTRACT

Systems, apparatuses, and methods for sending hybrid frames as part of an encoded video stream are disclosed. A system includes a transmitter and a receiver communicating wirelessly. The transmitter partitions a first frame of a video stream into a plurality of portions and sends the plurality of portions to the receiver. The transmitter records which portions of the first frame which were not acknowledged by the receiver. Next, the transmitter generates one or more first portions of a hybrid frame based only on data from a second frame of the video stream and the transmitter generates one or more second portions of the hybrid frame based on a comparison of data from the second frame to data of the first frame. The one or more first portions of the hybrid frame correspond to portions of the first frame which were not acknowledged by the receiver.

### BACKGROUND

### Description of the Related Art

Modern video compression standards, such as H.264 (i.e., Moving Pictures Experts Group (MPEG-4), Advanced Video Coding (MPEG-4 AVC)), reduce the amount of data which is used to represent a video stream. These video compression standards generally divide video frames into three types of frames. These three types of frames include Intra-coded frames (or I-frames), Predictive frames (or P-frames), and Bi-predictive frames (or B-frames).

An I-frame is a frame of a video stream which is encoded without reference to any other frame. Accordingly, an I-frame is an independent frame. I-frames are used as references for the decoding of other P-frames or B-frames. I-frames can be generated by an encoder to create random access points which allow a decoder to start decoding properly from scratch at a given location in the video stream. A P-frame can be generated based on an I-frame positioned in the video stream before the P-frame. A P-frame can also be referred to as a delta-frame. A P-frame contains encoded information regarding differences relative to a previous I-frame in the decoding order. A P-frame typically references the preceding I-frame in the video stream. P-frames can contain both image data and motion vector displacements and combinations of the two.

A B-frame can be a frame related to at least one of an I-frame, P-frame, and B-frame. For example, a B-frame can be generated based on an I-frame, P-frame, or B-frame positioned before the B-frame, and an I-frame, P-frame, or B-frame positioned after the B-frame. An advantage of using P-frames and B-frames is that these frames typically require less data for encoding than I-frames. However, the standard techniques used for generating P-frames and B-frames are not optimized for wireless video streaming. Accordingly, improved techniques for implementing wireless video streaming applications are desired.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one embodiment of a system.

FIG. 2 is a block diagram of one embodiment of a system implementing a wireless virtual reality (VR) application.

FIG. 3 is a diagram of one embodiment of a video stream.

FIG. 4 is a diagram of one embodiment of an I-frame and a hybrid P-frame.

FIG. 5 is a block diagram of one embodiment of a hybrid P-frame.

FIG. 6 is a generalized flow diagram illustrating one embodiment of a method for generating hybrid P-frames in a wireless VR system.

FIG. 7 is a generalized flow diagram illustrating another embodiment of a method for generating hybrid P-frames.

FIG. 8 is a generalized flow diagram illustrating one embodiment of a method for generating a hybrid encoded frame.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, methods, and computer-readable mediums for generating hybrid P-frames as part of a wirelessly transmitted video stream are disclosed herein. In one embodiment, a wireless communication system includes a transmitter and a receiver. In one embodiment, the transmitter is configured to encode a video stream and wirelessly transmit an encoded video stream to the receiver. In one embodiment, the video stream is part of a virtual reality (VR) rendered environment.

In one embodiment, the transmitter sends a first frame of a video stream to a receiver. In one embodiment, the transmitter generates an Intra-coded frame (I-frame) corresponding to the first frame and sends the I-frame to the receiver. In another embodiment, the transmitter generates a Predictive frame (P-frame) or hybrid P-frame from the first frame and sends the P-frame or hybrid P-frame to the receiver. In one embodiment, the transmitter sends the first frame as a series of portions (less than an entire frame) to the receiver, with each portion in a separate packet. The receiver is configured to send an acknowledgment (or ACK) for each portion which is received. Rather than resending portions that are not acknowledged by the receiver, the transmitter records which portions of the first frame are not acknowledged by the receiver. For latency-sensitive applications (e.g., VR applications), if a portion of the first frame is resent, the receiver is typically unable to use the portion since the receiver will already have displayed the first frame by the time the resent portion is received and decoded.

After sending the first frame, if any of the portions of the first frame were not acknowledged by the receiver, the transmitter generates a hybrid P-frame with one or more portions based on raw data of only a second frame of the video stream and one or more portions based on difference data of the second frame compared to the first frame. The one or more raw data portions of the second frame correspond to the portions of the first frame which were not acknowledged by the receiver. In one embodiment, similar to the first frame, the transmitter sends the hybrid P-frame as a series of portions of the hybrid P-frame to the receiver. For each portion of the hybrid P-frame, if the corresponding portion of the first frame was acknowledged by the receiver, then the transmitter generates the portion based on difference data between the second frame and the first frame. Otherwise, if the corresponding portion of the first frame was not acknowledged by the receiver, then the transmitter generates the portion based on raw data of the second frame. In one embodiment, the transmitter generates subsequent P-frames and Bi-predictive frames (B-frames) by comparing the current frame of the video stream to the previous frame for portions which were acknowledged by the receiver during transmission of the previous frame and by using only data of the current frame for portions which were not acknowledged by the receiver during transmission of the previous frame.

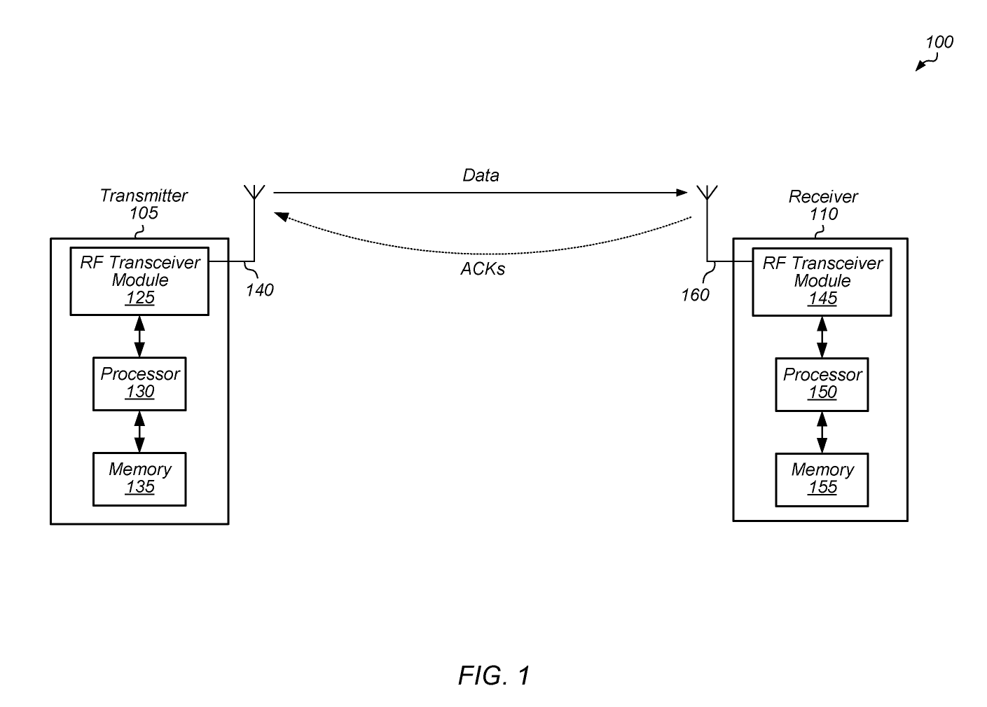

Referring now to FIG. 1, a block diagram of one embodiment of a system 100 is shown. System 100 includes at least a first communications device (e.g., transmitter 105) and a second communications device (e.g., receiver 110) operable to communicate with each other wirelessly. It is noted that receiver 110 can also transmit data and/or acknowledgments to transmitter 105. Accordingly, transmitter 105 and receiver 110 can also be referred to as transceivers. In one embodiment, transmitter 105 and receiver 110 communicate wirelessly over the unlicensed 60 Gigahertz (GHz) frequency band. For example, transmitter 105 and receiver 110 can communicate in accordance with the Institute of Electrical and Electronics Engineers (IEEE) 802.11ad standard (i.e., WiGig). In other embodiments, transmitter 105 and receiver 110 can communicate wirelessly over other frequency bands and/or by complying with other wireless communication standards.

Transmitter 105 and receiver 110 are representative of any type of communication devices and/or computing devices. For example, in various embodiments, transmitter 105 and/or receiver 110 can be a mobile phone, tablet, computer, server, head-mounted display (HMD), television, another type of display, router, or other types of computing or communication devices.

In various embodiments, system 100 is configured to execute latency sensitive applications. For example, in one embodiment, system 100 executes a virtual reality (VR) application for wirelessly transmitting frames of a rendered virtual environment from transmitter 105 to receiver 110. In other embodiments, other types of latency sensitive applications can be implemented by system 100 that take advantage of the methods and mechanisms described herein.

In one embodiment, transmitter 105 includes at least radio frequency (RF) transceiver module 125, processor 130, memory 135, and antenna 140. RF transceiver module 125 is configured to transmit and receive RF signals. RF transceiver module 125 converts baseband signals into RF signals for wireless transmission, and RF transceiver module 125 converts RF signals into baseband signals for reception by transmitter 105. It is noted that RF transceiver module 125 is shown as a single unit for illustrative purposes. It should be understood that RF transceiver module 125 can be implemented with any number of different units (e.g., chips) depending on the embodiment. Similarly, processor 130 and memory 135 are representative of any number and type of processors and memory devices, respectively, that can be implemented as part of transmitter 105.

Transmitter 105 also includes antenna 140 for transmitting and receiving RF signals. Although antenna 140 is shown as being external to transmitter 105, it should be understood that antenna 140 can be included internally within transmitter 105 in various embodiments. Additionally, it should be understood that transmitter 105 can also include any number of other components which are not shown to avoid obscuring the figure.

Similar to transmitter 105, the components implemented within receiver 110 include at least RF transceiver module 145, processor 150, memory 155, and antenna 160, which are similar to the components described above for transmitter 105. It should be understood that receiver 110 can also include or be coupled to other components (e.g., a display). In one embodiment, transmitter 105 is configured to send data packets to receiver 110. In one embodiment, receiver 110 is configured to send an acknowledgement for each data packet which is received correctly. It is noted that the term “received correctly” is defined as received with an acceptable number of errors. An acceptable number of errors can be a number of errors less than a given threshold. Alternatively, an acceptable number of errors can be a number of errors that allows the packet to be successfully decoded. In one embodiment, the receiver sends an ACK to the transmitter if the packet was received with an acceptable number of errors. If the received packet includes an unacceptable number of errors, the receiver does not send an ACK or the receiver sends an indication of unsuccessful decoding of the packet.

If a given data packet is lost or corrupted during transmission (e.g., receiver 110 does not acknowledge the given data packet sent by transmitter 105), rather than resending the given data packet, transmitter 105 stores an indication that the given data packet was not acknowledged. Then, transmitter 105 can modify how future data packets are generated based on any data packets which were not acknowledged by receiver 110. For example, transmitter 105 can utilize a given data compression scheme (e.g., H.264/MPEG-4 AVC) for compressing the data which is sent to receiver 110. Transmitter 105 can modify the given data compression scheme based on data packets which are not acknowledged by receiver 110. This modification of the given data compression scheme is implemented as an alternative to resending the data packets which are not acknowledged. In certain latency sensitive applications, modifying the given data compression scheme as an alternative to resending the data packets which are not acknowledged can result in improved performance of the applications. Additional details on modifying data compression schemes are presented in more detail below.

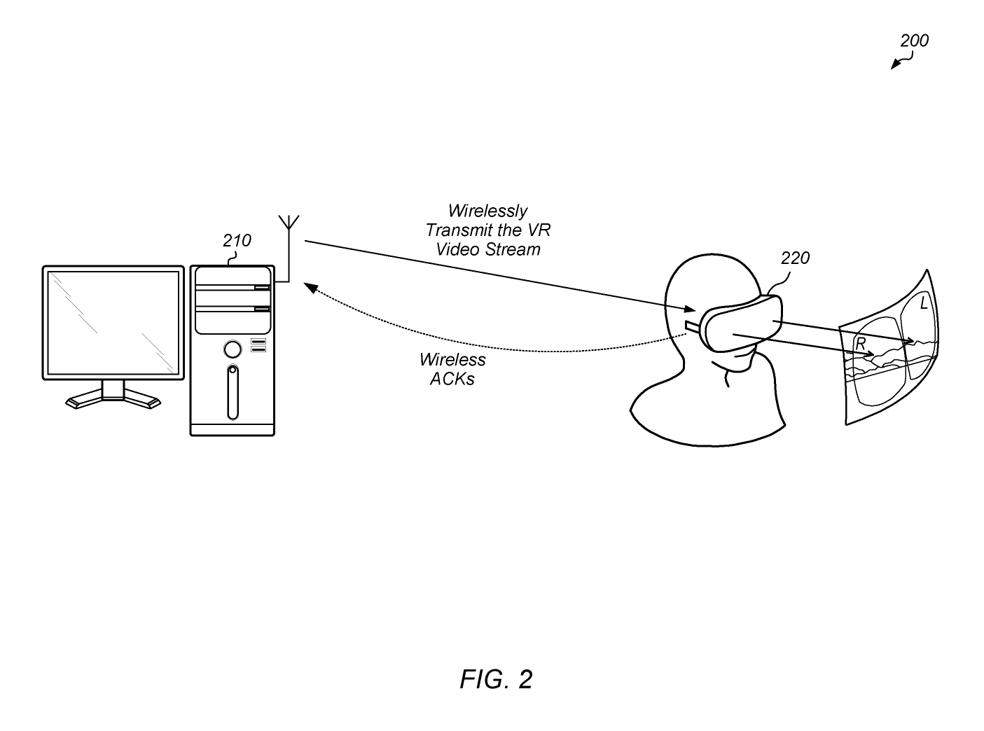

Turning now to FIG. 2, a block diagram of a wireless virtual reality (VR) system 200 is shown. System 200 includes at least computer 210 and head-mounted display (HMD) 220. Computer 210 is representative of any type of computing device which includes one or more processors, memory devices, input/output (I/O) devices, RF components, antennas, and other components indicative of a personal computer or other computing device. In other embodiments, other computing devices, besides a personal computer, can be utilized to send video data wirelessly to head-mounted display (HMD) 220.

In one embodiment, computer 210 includes circuitry configured to dynamically render a representation of a VR environment to be presented to a user wearing HMD 220. For example, in one embodiment, computer 210 includes one or more graphics processing units (GPUs) to render a VR environment. In other embodiments, computer 210 can include other types of processors, including a central processing unit (CPU), application specific integrated circuit (ASIC), field programmable gate array (FPGA), digital signal processor (DSP), or other processor types. HMD 220 includes circuitry to receive and decode a compressed bit stream sent by computer 210 to generate frames of the rendered VR environment. HMD 220 then drives the generated frames to the display integrated within HMD 220.

After rendering a frame of a virtual environment video stream, computer 210 encodes the rendered frame and then sends the encoded frame wirelessly to HMD 220. Transmitting the virtual video stream wirelessly eliminates the need for a cable connection between computer 210 and the user wearing HMD 220, thus allowing for unrestricted movement by the user. A traditional cable connection between a computer and HMD typically includes one or more data cables and one or more power cables. Allowing the user to move around without a cable tether and without having to be cognizant of avoiding the cable creates a more immersive VR system. Sending the VR video stream wirelessly also allows the VR system 200 to be utilized in a wider range of applications than previously possible.

Computer 210 and HMD 220 each include circuitry and/or components to communicate wirelessly. It should be understood that while computer 210 is shown as having an external antenna, this is shown merely to illustrate that the video data is being sent wirelessly. It should be understood that computer 210 can have an antenna which is internal to the external case of computer 210. Additionally, while computer 210 can be powered using a wired power connection, HMD 220 is typically battery powered. Alternatively, computer 210 can be a laptop computer powered by a battery.

In one embodiment, computer 210 is configured to send an encoded video frame a portion at a time to HMD 220. In one embodiment, HMD 220 is configured to acknowledge the receipt of a given portion of the encoded video frame by sending an acknowledgement (or ACK) to computer 210. If computer 210 does not receive an ACK for a given portion of the frame, rather than resending the given portion of the frame, computer 210 simply records an indication that the given portion of the frame was not received by HMD 220. Many VR applications are latency-sensitive, and if a portion of the frame of a VR video stream is resent, typically the portion will arrive too late to be displayed by HMD 220. Accordingly, computer 210 will not resend a portion of a frame which is not acknowledged by HMD 220. Rather, during the next frame of the VR video stream, if the next frame is being encoded as a P-frame, then computer 210 will generate the corresponding portion of the P-frame from raw data of this frame, as though this portion were part of a new I-frame. The remaining portions of the subsequent P-frame, corresponding to portions of the previous frame which were received by HMD 220, will be generated based on the difference data between this frame and the previous frame. This pattern can continue for subsequent P-frames.

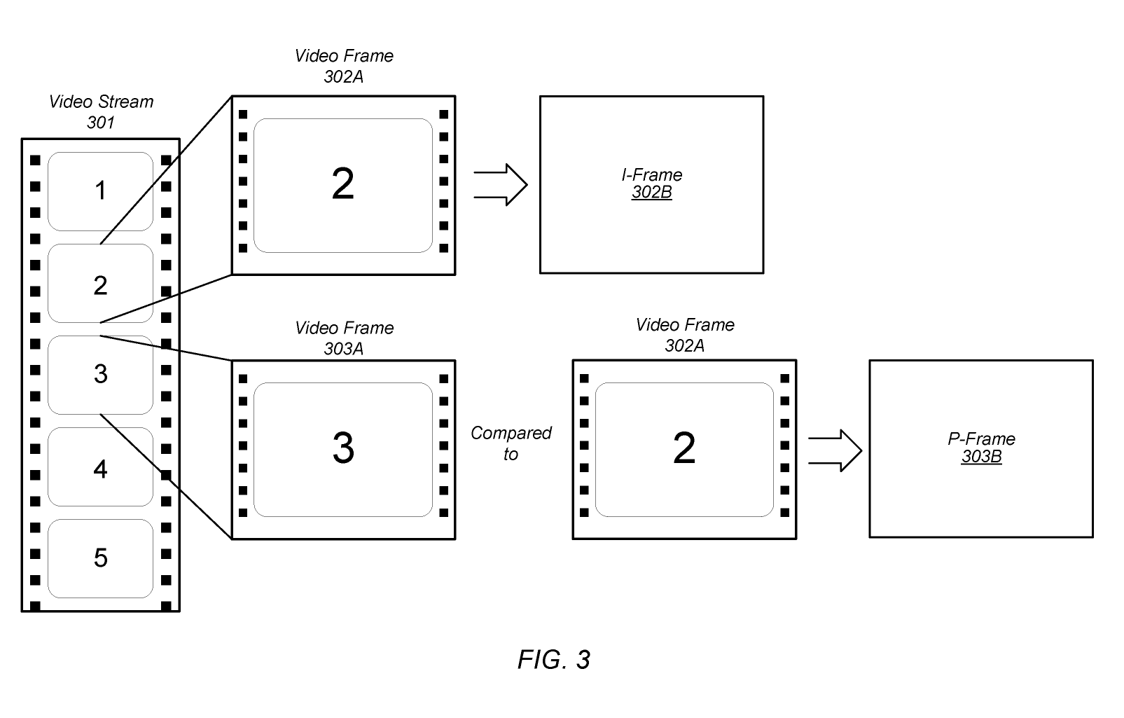

Referring now to FIG. 3, a diagram of one embodiment of a video stream 301 is shown. The individual frames of a sample video stream 301 are shown on the left side of FIG. 3. The second video frame of video stream 301 is expanded and shown as video frame 302A. The contents of video frame 302A can be compressed and transmitted wirelessly from a transmitter (e.g., computer 210 of FIG. 2) to a receiver (e.g., HMD 220) as I-frame 302B. It is noted that I-frame 302B is compressed only with reference to video frame 302A.

Then, after I-frame 302B is sent wirelessly from the transmitter to the receiver, the next video frame 303A is prepared for transmission. To reduce the amount of data which needs to be sent to the receiver for video frame 303A, video frame 303A can be sent as a P-frame, which is encoded based on the differences between video frame 303A and the previous video frame 302A. Accordingly, the differences between the current video frame (video frame 303A) and the previous video frame (video frame 302A) are calculated. Then, the differences between the current and previous frame are used to generate as P-frame 303B. P-frame 303B can then be sent from the transmitter to the receiver.

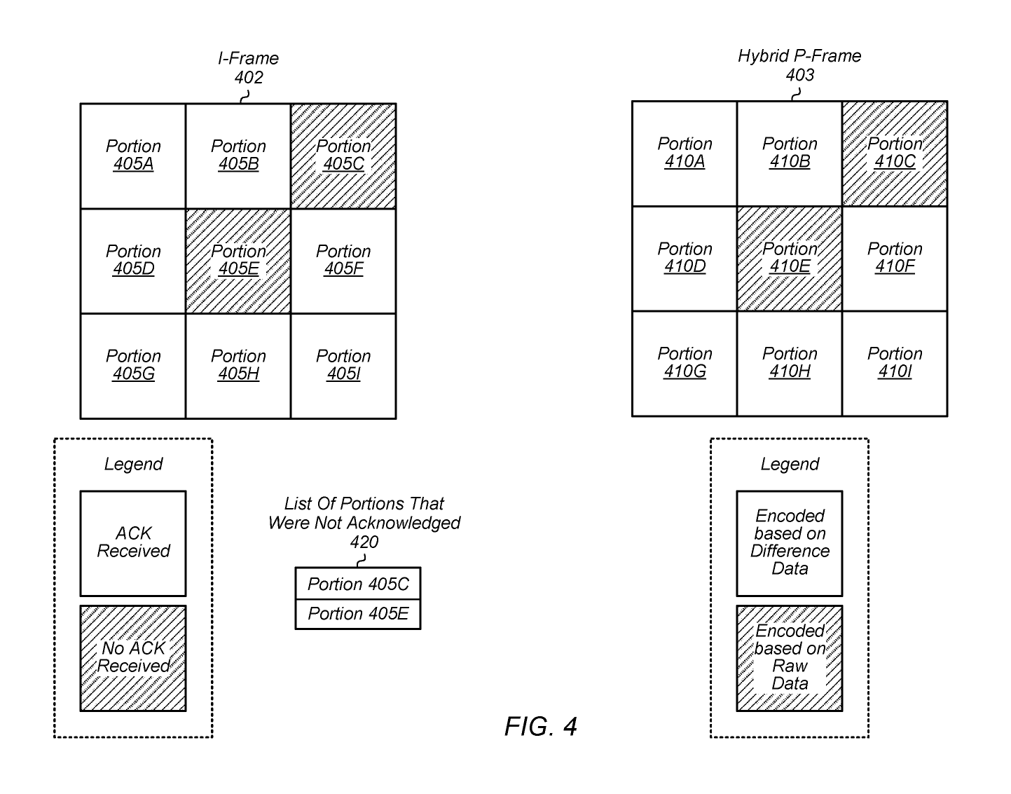

Turning now to FIG. 4, a diagram of one embodiment of an I-frame 402 and a hybrid P-frame 403 are shown. It is assumed for the purposes of this discussion that I-frame 402 and hybrid P-frame 403 are generated from back-to-back frames of a video stream. Accordingly, I-frame 402 can be encoded and sent from a transmitter (e.g., computer 210 of FIG. 2) to a receiver (e.g., HMD 220) based on a first frame of a video stream and then hybrid P-frame 403 can be generated based on a second frame of the video stream compared to the first frame and then sent from the transmitter to the receiver, wherein the first and second frames are back-to-back frames of the video stream. It is noted that hybrid P-frame 403 is not a traditional P-frame, in that some of the portions of P-frame 403 can be sent as encoded versions of the original, raw pixel data of the second frame rather than as the encoded versions of differences between the second frame pixel data and the first frame pixel data. As used herein, the term “raw data” refers to the original pixel data of the current video frame without comparing the pixel data to any other video frames.

I-frame 402 is representative of a video frame of a video stream which is sent from the transmitter to the receiver. I-frame 402 is sent as the encoded version of the original, raw pixel data of the video frame without reference to any other video frames. In one embodiment, I-frame 402 is sent one portion at a time from the transmitter to the receiver. It is noted that the term “portion” of a frame can also be referred to as a “region”, “chunk”, or “tile”. As shown in FIG. 4, I-frame 402 can be sent as individual portions 405A-I. It should be understood that the example of I-frame 402 being partitioned into nine separate portions is intended to represent one particular example for the purposes of illustrations. In other embodiments, I-frame 402 can be partitioned into other numbers of portions. Additionally, although portions 405A-I are shown as being equal-sized, it should be understood that portions 405A-I can vary in size in other embodiments.

In one embodiment, the transmitter sends each portion 405A-N of I-frame 402 separately to the receiver. In one embodiment, the transmitter receives an acknowledgment (or ACK) from the receiver for each portion 405A-N which is received and able to be decoded. In some embodiments, the receiver can aggregate ACKs and transmit them in a single transmission. For example, the receiver can send a block ACK which lists which portions were received and/or decoded by the receiver, rather than sending an individual ACK for each portion 405A-N. It is assumed for the purposes of this discussion that the transmitter did not receive an ACK for portions 405C and 405E. These portions 405C and 405E are shown with diagonal lines to indicate that they have not been acknowledged as having been received by the receiver. It can be possible in some cases for the receiver to send an ACK for a given portion of I-frame 402, but for the transmitter not to receive the ACK. In these cases, the transmitter will treat these portions as though they were not received by the receiver.

In one embodiment, the transmitter maintains a list 420 of portions of I-frame 402 for which an ACK was not received. List 420 can be implemented using any type of structure (e.g., linked list), with the type of structure varying according to the embodiment. The transmitter can utilize list 420 when generating hybrid P-frame 403. For the portions of I-frame 402 which were acknowledged by the receiver (the portions shown without diagonal lines in I-frame 402), the corresponding portions of hybrid P-frame 403 are generated and encoded based on the difference between the current frame and the previous frame. For the portions which were not acknowledged by the receiver (the portions shown with diagonal lines in I-frame 402), the corresponding portions of hybrid P-frame 403 are generated and encoded based on the raw data of the current frame. Accordingly, these portions are sent as if they were portions of a new I-frame rather than portions of a P-frame. Hence, hybrid P-frame 403 is generated with some portions based on raw data and some portions based on difference data rather than being generated as a traditional P-frame (e.g., P-frame 303B of FIG. 3). It is noted that hybrid P-frame 403 is partitioned into portions which match the sizes and locations of portions of I-frame 402 within the original video frame. In one embodiment, the transmitter sends an indication with each portion of hybrid P-frame 403 to notify the receiver if the portion is encoded based on raw data or difference data. The receiver can then utilize these indications to properly decode each received portion of hybrid P-frame 403.

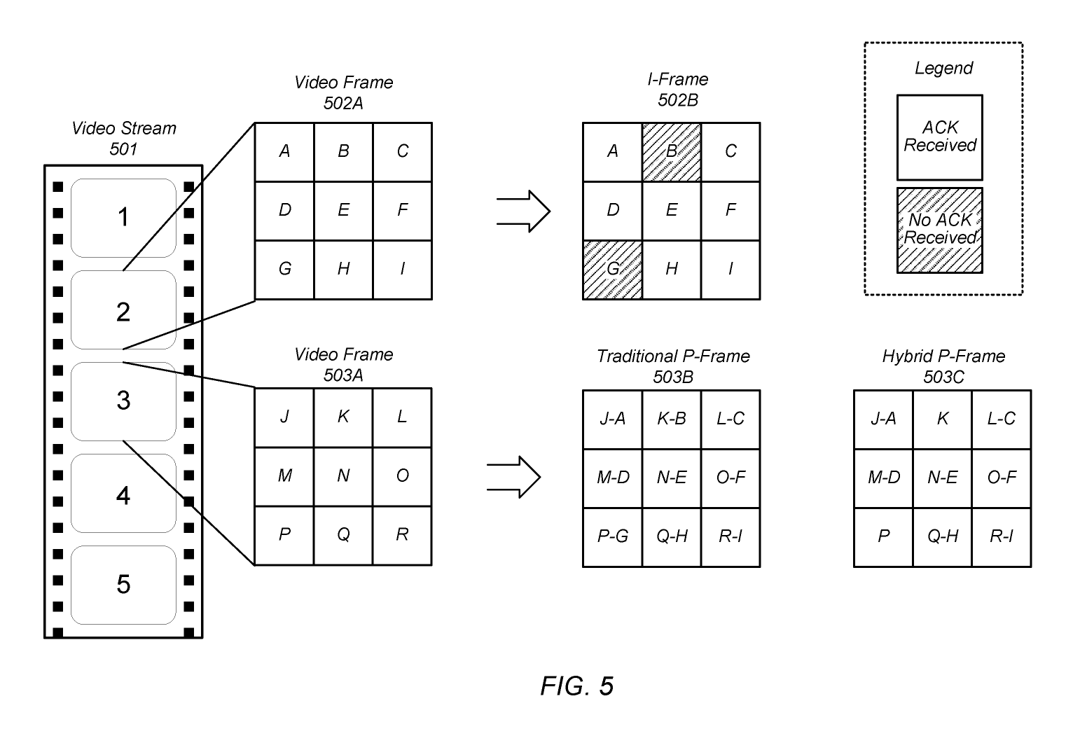

Referring now to FIG. 5, a block diagram of one embodiment of a hybrid P-frame 503C is shown. The video stream 501 is shown on the left-side of FIG. 5. Two consecutive video frames of video stream 501 are expanded into video frames 502A and 503A. The letters A-I shown in the portions of video frame 502A are meant to be representative of the values of these portions. Similarly, the letters J-R in the portions of video frame 503A are meant to be representative of the values of these portions.

In one embodiment, the raw data of video frame 502A is used to generate I-frame 502B which is sent from a transmitter to a receiver. It is assumed for the purposes of this discussion that the portions of I-frame 502B with diagonal lines were not acknowledged by the receiver. Accordingly, indications that these portions were not acknowledged by the receiver can be recorded by the transmitter and used when generating hybrid P-frame 503C.

The example of traditional P-frame 503B is meant to represent how a traditional P-frame would be generated based on the data of video frames 502A and 503A. The traditional P-frame 503B is encoded based on the differences between the data of video frames 503A and 502A. This is shown as each portion including the difference between the data of the corresponding portions in video frames 503A and 502A. For example, the top left portion of traditional P-frame 503B is encoded based on the difference data J-A, the top center portion of traditional P-frame 503B is encoded based on the difference data K-B, and so on. The traditional P-frame 503B does not take into account which portions of I-frame 502B were not acknowledged by the receiver.

On the other hand, when generating hybrid P-frame 503C, the transmitter takes into account which portions of I-frame 502B were not acknowledged by the receiver. For these portions of I-frame 502B which were not acknowledged by the receiver, the corresponding portions of hybrid P-frame 503C will be encoded based on the raw data of video frame 503A rather than the difference data between video frame 503A and video frame 502A. Accordingly, the top middle portion of hybrid P-frame 503C will be encoded based on the data “K” which is the raw data from the top middle portion of video frame 503A. Also, the bottom left portion of hybrid P-frame 503C will be encoded based on the data “P” which is the raw data from the bottom left portion of video frame 503A. The remaining portions of hybrid P-frame 503C, corresponding to portions of I-frame 502B which were acknowledged by the receiver, are encoded based on the difference data.

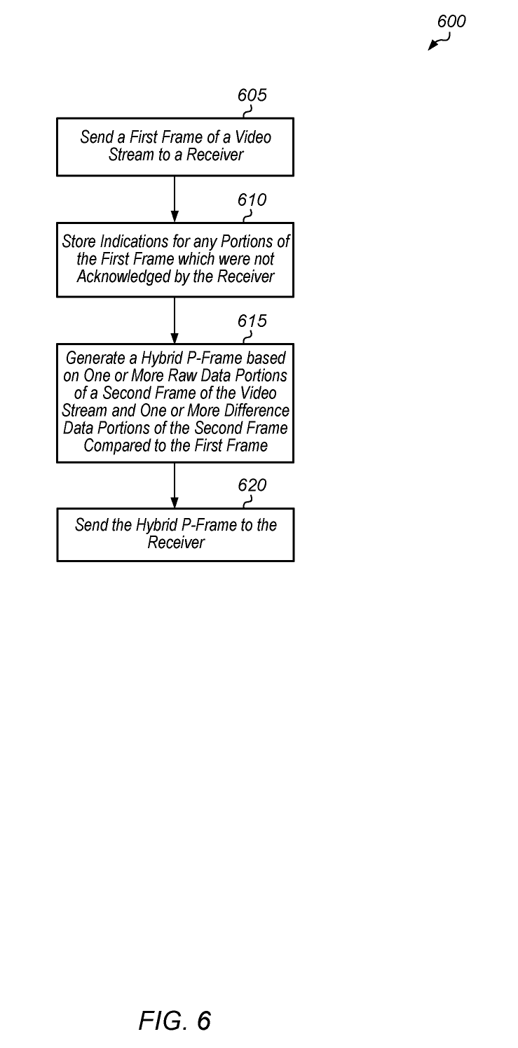

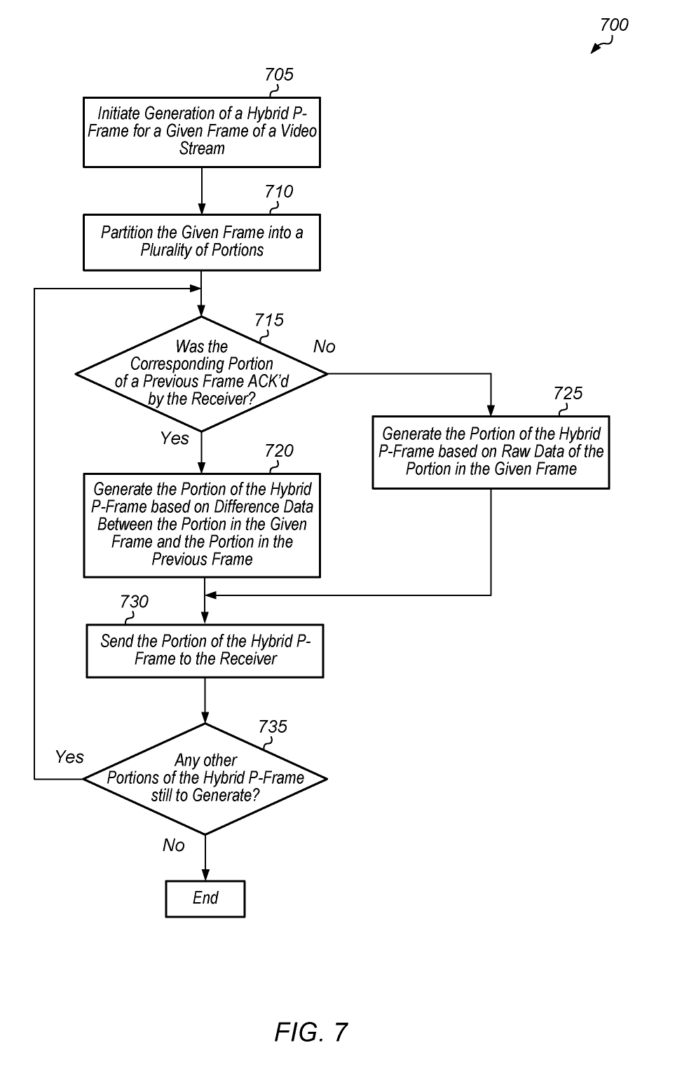

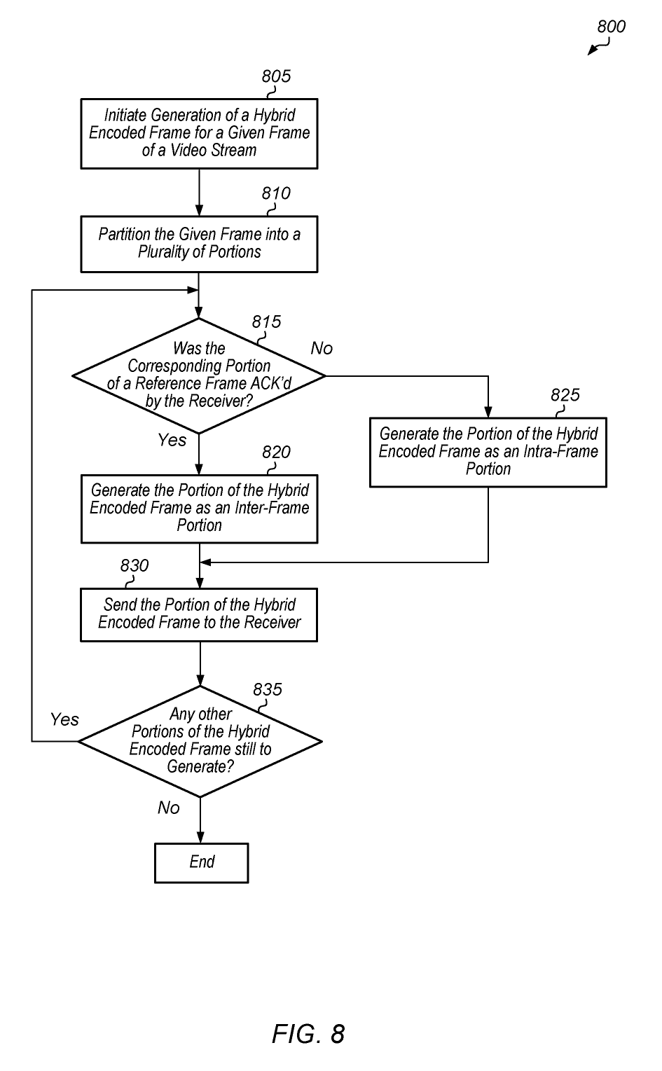

Turning now to FIG. 6, one embodiment of a method 600 for generating hybrid P-frames in a wireless VR system is shown. For purposes of discussion, the steps in this embodiment and those of FIG. 7-8 are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 600.

A transmitter sends a first frame of a video stream to a receiver (block 605). In one embodiment, the transmitter generates an I-frame from a frame of a video stream and transmits the I-frame to the receiver. In another embodiment, the transmitter generates a P-frame from the frame of the video stream and transmits the P-frame to the receiver. In a further embodiment, the transmitter generates a hybrid P-frame based on at least two frames of the video stream and transmits the hybrid P-frame to the receiver. In one embodiment, the transmitter sends the first frame a portion at a time to the receiver, with each portion in a separate packet. In one embodiment, the video stream is rendered as part of a VR environment. The transmitter and the receiver can be any types of computing devices, with the type of computing device varying according to the embodiment. In one embodiment, the transmitter is a computer and the receiver is a HMD. In other embodiments, the transmitter and/or the receiver can be other types of computing devices. Next, the transmitter stores indications for any portions of the first frame which were not acknowledged by the receiver (block 610).

Then, the transmitter generates a hybrid P-frame based on one or more raw data portions of a second frame of the video stream and one or more difference data portions of the second frame compared to the first frame (block 615). The term “hybrid P-frame” is defined as a frame that, at least in some cases, includes one or more P-frame portions and one or more I-frame portions. Next, the transmitter sends the hybrid P-frame to the receiver (block 620). It is noted that the transmitter can send the hybrid P-frame a portion at a time to the receiver as each portion is generated without waiting until the entire hybrid P-frame has been generated or is otherwise ready to send. After block 620, method 600 ends. It is noted that blocks 610, 615, and 620 of method 600 can be repeated for subsequent hybrid P-frames of the video stream.

Referring now to FIG. 7, another embodiment of a method 700 for generating hybrid P-frames is shown. A transmitter initiates generation of a hybrid P-frame for a given frame of a video stream (block 705). In one embodiment, the previous frame of the video stream (i.e., the frame immediately preceding the given frame in the video stream) was sent as an I-frame by the transmitter to a receiver. In another embodiment, the previous frame was sent as a P-frame or as a hybrid P-frame by the transmitter to the receiver. Generally speaking, the transmitter can send one I-frame to the receiver followed by an indefinite number of hybrid P-frames.

The transmitter partitions the given frame into a plurality of portions (block 710). For each portion of the given frame, the transmitter determines if the corresponding portion of a previous frame was acknowledged by a receiver (conditional block 715). In one embodiment, the transmitter maintains a list which indicates which portions of the previous frame were acknowledged by the receiver.

If the corresponding portion of the previous frame was acknowledged by the receiver (conditional block 715, “yes” leg), then the transmitter generates the portion of the hybrid P-frame based on difference data between the portion in the given frame and the portion in the previous frame (block 720). If the corresponding portion of the previous frame was not acknowledged by the receiver (conditional block 715, “no” leg), then the transmitter generates the portion of the hybrid P-frame based on raw data of the portion in the given frame (block 725). Then, the transmitter sends the portion of the hybrid P-frame to the receiver (block 730). Then, the transmitter determines if there are any other portions of the hybrid P-frame which still need to be generated (conditional block 735). If there are any other portions of the hybrid P-frame to generate (conditional block 735, “yes” leg), then method 700 returns to conditional block 715. If there are no more portions of the hybrid P-frame to generate (conditional block 735, “no” leg), then method 700 ends.

Turning now to FIG. 8, one embodiment of a method 800 for generating a hybrid encoded frame is shown. A transmitter initiates generation of a hybrid encoded frame for a given frame of a video stream (block 805). The term “hybrid encoded frame” is defined as a frame that, at least in some cases, utilizes multiple encoding schemes for different portions of the frame. An example of a hybrid encoded frame is a frame with at least one portion generated as a P-frame portion and at least one portion generated as an I-frame portion. Other types of hybrid encoded frames can also be generated. The transmitter partitions the given frame into a plurality of portions (block 810). For each portion of the given frame, the transmitter determines if the corresponding portion of a previously sent reference frame was acknowledged by a receiver (conditional block 815).

If the corresponding portion of the previously sent reference frame was acknowledged by the receiver (conditional block 815, “yes” leg), then the transmitter generates the portion of the hybrid encoded frame as an inter-frame portion (block 820). As used herein, the term “inter-frame” is defined as a frame which is encoded based on one or more neighboring frames of the video stream. Examples of inter-frames include P-frames and B-frames. If the corresponding portion of the previously sent reference frame was not acknowledged by the receiver (conditional block 815, “no” leg), then the transmitter generates the portion of the hybrid encoded frame as an intra-frame portion of the given frame (block 825). As used herein, the term “intra-frame” is defined as a frame which is encoded based only on the pixel values of the current frame of the video stream. An example of an intra-frame is an I-frame. Then, the transmitter sends the portion of the hybrid encoded frame to the receiver (block 830).

Next, the transmitter determines if there are any other portions of the hybrid encoded frame which still need to be generated (conditional block 835). If there are any other portions of the hybrid encoded frame to generate (conditional block 835, “yes” leg), then method 800 returns to conditional block 815. If there are no more portions of the hybrid encoded frame to generate (conditional block 835, “no” leg), then method 800 ends.

In various embodiments, program instructions of a software application are used to implement the methods and/or mechanisms previously described. Such a software program can then be executed by one or more processors or processing devices in a computing environment. In some embodiments, the program instructions can be represented by a high-level programming language which is then compiled for execution. In other embodiments, the program instructions can be represented by firmware accessible by a processing device. In further embodiments, a hardware based implementation of the above described embodiments can be made. For example, program instructions that describe the behavior of hardware in a high-level programming language, such as C, Verilog, VHDL, or otherwise can be generated by a designer. Those instructions can then be used to create a desired hardware implementation. These and other embodiments are possible and are contemplated.

In one embodiment, the program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a transmitter; and
a receiver;
wherein the transmitter is configured to:
partition a first frame of a video stream into a plurality of portions;
send the plurality of portions of the first frame to the receiver;
store indications for any portions of the plurality of portions of the first frame which were not acknowledged as being received by the receiver;
generate one or more portions of a hybrid frame based only on data from a second frame of the video stream; and
generate one or more portions of the hybrid frame based on a comparison of data from the second frame to data of the first frame.

2. The system as recited in claim 1, wherein the first frame is an intra-coded frame (I-frame), and wherein for each portion of a plurality of portions of the hybrid frame, the transmitter is configured to:
generate the portion based only on data from the first frame if the portion corresponds to a portion of the I-frame which was not acknowledged by the receiver during transmission of the I-frame; and
generate the portion based on difference data of the second frame compared to the first frame if the portion corresponds to a portion of the I-frame which was acknowledged by the receiver during transmission of the I-frame.

3. The system as recited in claim 1, wherein the transmitter is configured to send an indication with each portion of the hybrid frame to notify the receiver if the portion was generated based only on data from the second frame or generated based on a comparison of data from the second frame to data of the first frame.

4. The system as recited in claim 1, wherein the transmitter is configured to partition the hybrid frame into a plurality of portions matching the plurality of portions of the first frame.

5. The system as recited in claim 1, wherein the second and first frames are back-to-back frames of the video stream, and wherein the transmitter is configured to send the first frame and hybrid frame wirelessly to the receiver.

6. The system as recited in claim 1, wherein rather than resending a given portion of the first frame which was not acknowledged by the receiver, the transmitter stores an indication that the given portion was not acknowledged.

7. The system as recited in claim 1, wherein the first frame is a hybrid frame.

8. A method comprising:
partitioning a first frame of a video stream into a plurality of portions;
sending the plurality of portions of the first frame to a receiver;
storing indications for any portions of the plurality of portions of the first frame which were not acknowledged as being received by the receiver;
generating one or more portions of a hybrid frame based only on data from a second frame of the video stream; and
generating one or more portions of the hybrid frame based on a comparison of data from the second frame to data of the first frame.

9. The method as recited in claim 8, wherein the first frame is an intra-coded frame (I-frame), and wherein for each portion of a plurality of portions of the hybrid P-frame, the method further comprising:
generating the portion based only on data from the first frame if the portion corresponds to a portion of the I-frame which was not acknowledged by the receiver during transmission of the I-frame; and
generating the portion based on difference data of the second frame compared to the first frame if the portion corresponds to a portion of the I-frame which was acknowledged by the receiver during transmission of the I-frame.

10. The method as recited in claim 8, further comprising sending an indication with each portion of the hybrid P-frame to notify the receiver if the portion was generated based only on data from the second frame or generated based on a comparison of data from the second frame to data of the first frame.

11. The method as recited in claim 8, further comprising partitioning the hybrid frame into a plurality of portions matching the plurality of portions of the first frame.

12. The method as recited in claim 8, wherein the second and first frames are back-to-back frames of the video stream, and wherein the method further comprising sending the first frame and hybrid frame wirelessly to the receiver.

13. The method as recited in claim 8, wherein rather than resending a given portion of the first frame which was not acknowledged by the receiver, the method comprising storing an indication that the given portion was not acknowledged.

14. The method as recited in claim 8, wherein the first frame is a hybrid frame.

15. A transmitter comprising:
a processor; and
a memory;
wherein the transmitter is configured to:
partition a first frame of a video stream into a plurality of portions;
send the plurality of portions of the first frame to a receiver;
store, by the processor in the memory, indications for any portions of the I-frame which were not acknowledged as being received by the receiver;
generate one or more portions of a hybrid frame based only on data from a second frame of the video stream; and
generate one or more portions of the hybrid frame based on a comparison of data from the second frame to data of the first frame.

16. The transmitter as recited in claim 15, wherein the first frame is an intra-coded frame (I-frame), and wherein for each portion of a plurality of portions of the hybrid P-frame, the transmitter is configured to:
generate the portion based only on data from the first frame if the portion corresponds to a portion of the I-frame which was not acknowledged by the receiver during transmission of the I-frame; and
generate the portion based on difference data of the second frame compared to the first frame if the portion corresponds to a portion of the I-frame which was acknowledged by the receiver during transmission of the I-frame.

17. The transmitter as recited in claim 15, wherein the transmitter is configured to send an indication with each portion of the hybrid frame to notify the receiver if the portion was generated based only on data from the second frame or generated based on a comparison of data from the second frame to data of the first frame.

18. The transmitter as recited in claim 15, wherein the transmitter is configured to partition the hybrid frame into a plurality of portions matching the plurality of portions of the first frame.

19. The transmitter as recited in claim 15, wherein the second and first frames are back-to-back frames of the video stream, and wherein the transmitter is configured to send the first frame and hybrid frame wirelessly to the receiver.

20. The transmitter as recited in claim 15, wherein rather than resending a given portion of the first frame which was not acknowledged by the receiver, the transmitter stores an indication that the given portion was not acknowledged.
